(19) United States
(12) Patent Application Publication
(10) Pub. No.: US 2004/0122751 A1
(43) Pub. Date: Jun. 24, 2004

(54) Systems and methods for processing reimbursement

(76) Inventors: Barry D. Kurtz, Meridian, ID (US); Jeffrey K. Larsen, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/325,291

(22) Filed: Dec. 19, 2002

(51) Int. Cl. G06F 17/60

(52) U.S. Cl. 705/30

(57) ABSTRACT

Disclosed are systems and methods for processing reimbursement. In one embodiment, a system for processing reimbursement includes an off-site reimbursement manager configured to gather data corresponding to reimbursable items and send the data to a central reimbursement manager configured to receive the data corresponding to the reimbursable items via the network and reimburse in accordance with the received data. In one embodiment, a method for processing reimbursement includes gathering data corresponding to reimbursable items in a first location and sending the data via a network to a second location.

### FIELD OF THE DISCLOSURE

The present disclosure relates to computers, and more particularly, the disclosure relates to systems and methods for processing reimbursement.

### BACKGROUND

With the technological advances in today's society, many employees have the opportunity to work at a location other than the employer's office. For example, the increase in home networking installations and wireless equipment provides a greater opportunity for the mobile professional to work at home or anywhere having network access. In this regard, employees may work in a location where no office supplies or office equipment are accessible. Therefore, while the employees are able to work at an off-site location, the employees are required to incur out-of-pocket expenses for resources they consume, such as paper and printer ink.

Employers typically reimburse employees for their business-related expenses, particularly for travel-related expenses. Normally, a reimbursement system requires the employee to submit a reimbursement form to the employer's accounting department. The accounting department then manually processes the information provided by the employee that contains expenses incurred during their work-related travel. Unfortunately, the reimbursement system requires man-power and reimbursement forms which can be expensive and time consuming.

Employers are often looking for ways to reduce inventory, which must be maintained, stored, and tracked. In addition, most employers like to encourage employees to work at home or at other off-site locations to increase employee output. One way to accomplish both goals is to reimburse employees for any expenses incurred while working on any work-related matter at the off-site location, including those expenses related to the consumption of employee owned resources.

From the above, it can be appreciated that it would be desirable to have a system and method for processing reimbursement for expenses incurred while working at an offsite location.

### SUMMARY OF THE DISCLOSURE

Disclosed are systems and methods for processing reimbursement. In one embodiment, a system for processing reimbursement includes an off-site reimbursement manager configured to gather data corresponding to reimbursable items and send the data to a central reimbursement manager configured to receive the data corresponding to the reimbursable items via the network and reimburse in accordance with the received data.

In one embodiment, a method for processing reimbursement includes gathering data corresponding to reimbursable items in a first location and sending the data via a network to a second location.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system through which reimbursement can be processed.

FIG. 2 is a block diagram of an embodiment of a central computing device shown in FIG. 1.

FIG. 3 is a block diagram of an embodiment of a user computing device shown in FIG. 1.

FIG. 4 is a block diagram of an embodiment of a printing device shown in FIG. 1.

FIG. 5 is a flow diagram that illustrates an embodiment of operation of the system shown in FIG. 1 in processing reimbursement.

FIG. 6 is a flow diagram that illustrates an embodiment of operation of an off-site reimbursement manager of the user computing device shown in FIG. 3.

FIG. 7 is a flow diagram that illustrates an embodiment of operation of a central reimbursement manager of the central computing device shown in FIG. 2.

### DETAILED DESCRIPTION

Disclosed herein are systems and methods through which the reimbursement of reimbursable items can be processed. In particular, the reimbursement can be achieved via a network, and data corresponding to reimbursable items may be gathered at an off-site location. Example systems are first discussed with reference to the figures. Although these systems are described in detail, they are provided for purposes of illustration only and various modifications are feasible. After the example systems have been described, examples of operation of the systems are provided to explain the manners in which the reimbursement processing can be achieved.

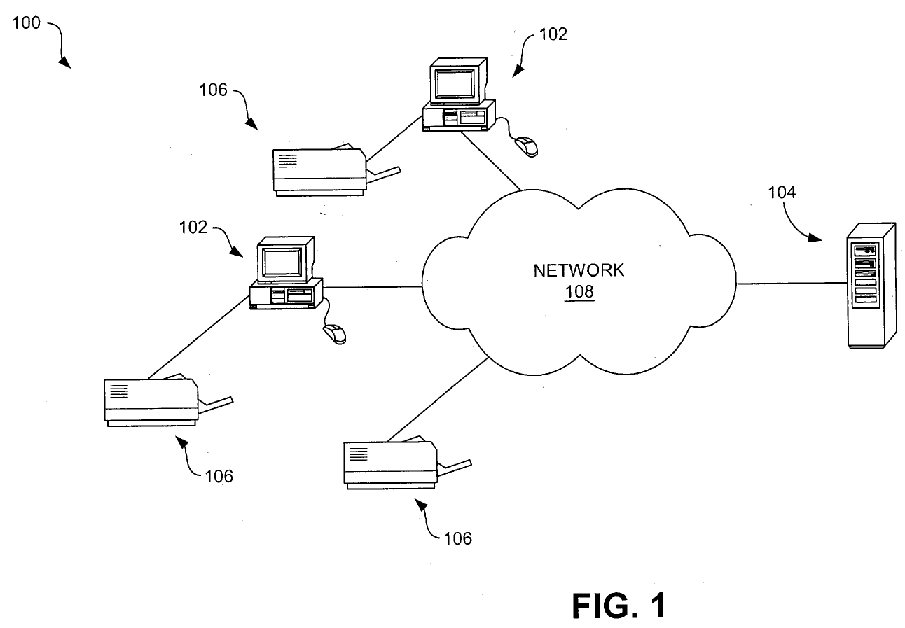

Referring now in more detail to the figures in which like reference numerals identify corresponding parts, FIG. 1 illustrates an example system 100 in which reimbursement can be processed. As indicated in this figure, the system 100 generally comprises one or more user computing devices 102, a central computing device 104, and one or more printing devices 106. As shown in FIG. 1, the user computing devices 102 can, for instance, comprise desktop or laptop personal computers (PCs) or Macintosh computers, handheld computers or computerized cell phones. The user computing devices 102, are typically located in an off-site (i.e., non-employer) location, such as the employee's home. In the embodiment shown in FIG. 1, each of these user computing devices 102 may communicate with a printing device 106 either directly or via a network 108. Similarly, the central computing device 104 may communicate with at least one printing device 106.

By way of example, the printing devices 106 comprise one of a printer, photocopier, facsimile machine, multifunction peripheral (MFP) device, all-in-one device, etc. More generally, however, the printing devices 106 comprise any device capable of generating hardcopy documents and therefore consuming employee-purchased resources.

As indicated in FIG. 1, the user computing devices 102 may communicate to the central computing device 104 via the network 108. In addition, the central computing device 104 may communicate to the printing device 106 via a network 108 without communicating through a user computing device 102. In this regard, the printing device 106 may, for example, include embedded network services that support communication between the printing device 106 and the central computing device 104 via network protocols.

The network 108 may comprise one or more sub-networks that are communicatively coupled to each other. By way of example, these networks include one or more local area networks (LANs) and/or wide area networks (WANs).

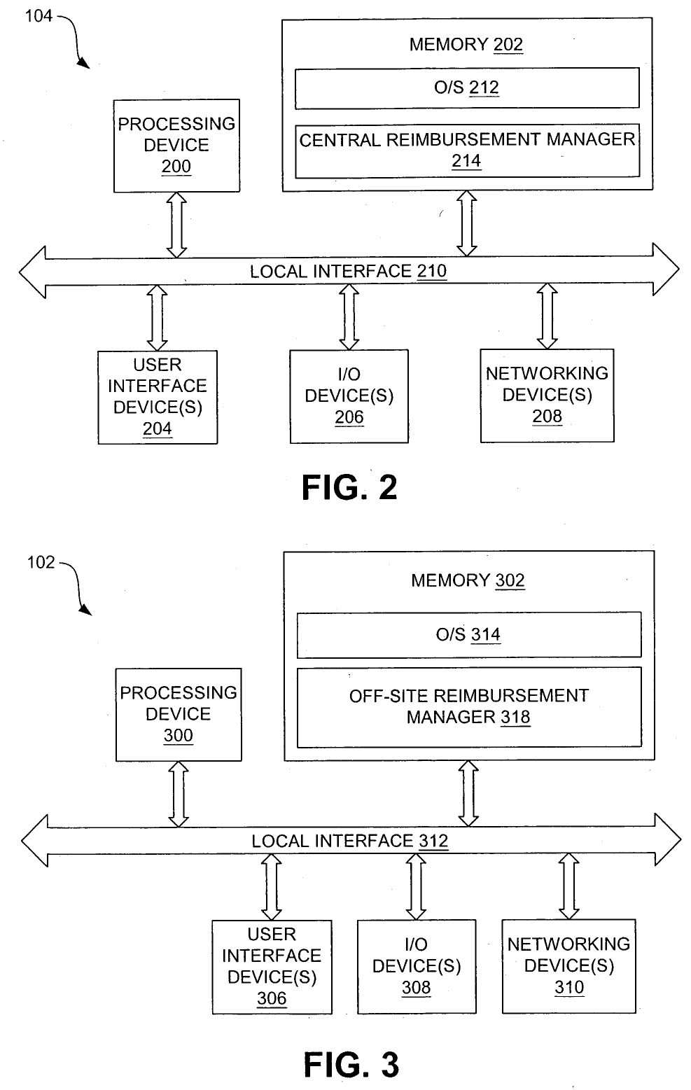

FIG. 2 is a block diagram illustrating an example architecture for the central computing device 104 shown in FIG. 1. As indicated in FIG. 2, the central computing device 104 comprises a processing device 200, memory 202, one or more user interface devices 204, one or more I/O devices 206, and one or more networking devices 208, each of which is connected to a local interface 210. The processing device 200 can include any custom made or commercially available processor, a central processing unit (CPU) or an auxiliary processor among several processors associated with the central computing device 104, a semiconductor based microprocessor (in the form of a microchip), or a microprocessor. The memory 202 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user (e.g., administrator) can interact with the central computing device 104. Where the central computing device 104 comprises a server computer or similar device, these components can comprise those typically used in conjunction with a PC such as a keyboard and mouse.

The one or more I/O devices 206 comprise components used to facilitate connection of the central computing device to other devices and therefore, for instance, comprise one or more serial, parallel, small system interface (SCSI), universal serial bus (USB), or IEEE 1394 (e.g., Firewire™) connection elements. The networking devices 208 comprise the various components used to transmit and/or receive data over the network 108, where provided. By way of example, the networking devices 208 include a device that can communicate both inputs and outputs, for instance, a modulator/demodulator (e.g., modem), a radio frequency (RF) or infrared (IR) transceiver, a telephonic interface, a bridge, a router, as well as a network card, etc.

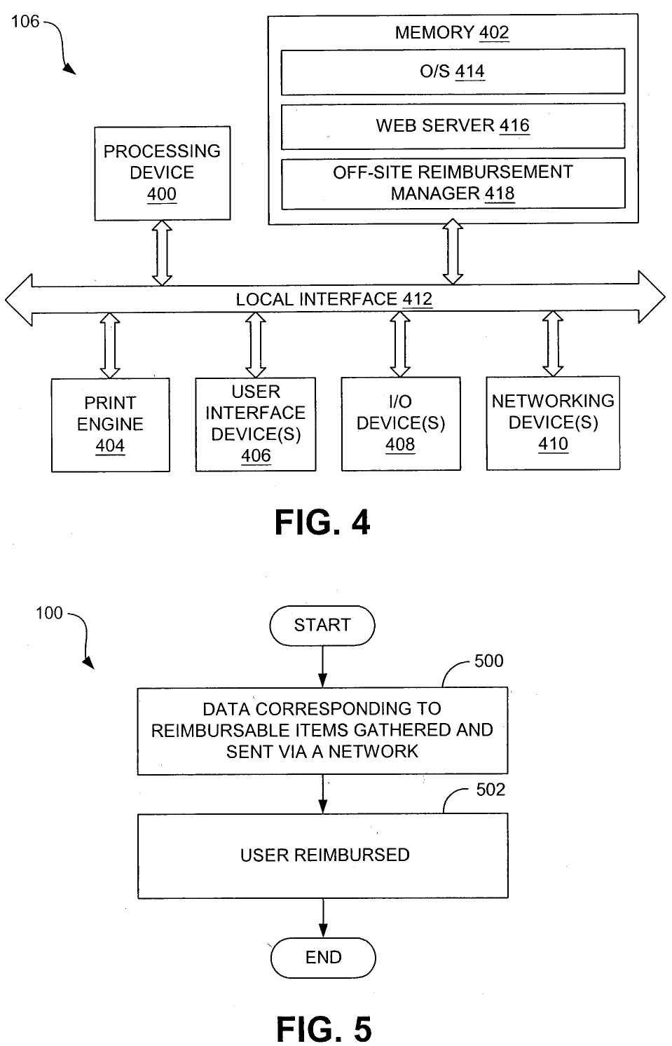

The memory 202 normally comprises various programs (in software and/or firmware) including an operating system (O/S) 212 and a central reimbursement manager 214. The O/S 212 controls the execution of programs, including the central reimbursement manager 214, and provides scheduling, input-output control, file and data management, memory management, and communication control and related services. The central reimbursement manager 214 facilitates the process for crediting and debiting of reimbursable items. Typically, the process involves receiving data corresponding to the reimbursable items via a network 108, such as the Internet, and reimbursing in accordance with the received data. Operation of the central reimbursement manager 214 is described in relation to FIGS. 4 and 5.

FIG. 3 is a block diagram illustrating an example architecture for the user computing devices 102 shown in FIG. 1. The architecture for the computing devices 102 is similar to the architecture of the central computing device 104 described above and therefore includes a processing device 300, one or more user interface devices 306, one or more I/O devices 308, and one or more networking devices 310, each of which is connected to a local interface 312.

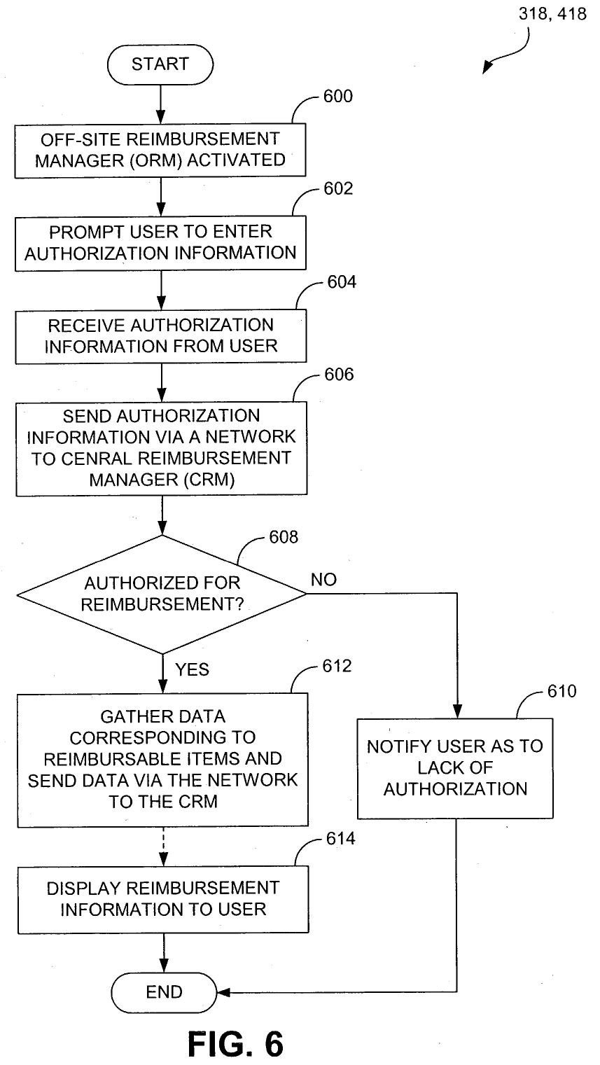

The memory 302 in the user computing device 102, however, includes an off-site reimbursement manager 318 that facilitates reimbursement for work-related matters. Typically, the reimbursement manager 318 provides data corresponding to reimbursable items via the network 108. Operation of the off-site reimbursement manager 318 is described with respect to FIGS. 4 and 6.

FIG. 4 is a block diagram illustrating an example architecture of a printing device 106 shown in FIG. 1 that can communicate with the central computing device 104 via the network 108 without communicating through a user computing device 102. The architecture for the printing device 106 is similar to the architecture of the user computing devices 102 and therefore includes a processing device 400, memory 402, I/O devices 408, and networking devices 410, each of which has a configuration similar to those described above, and each being connected to a local interface 412.

In addition, however, the printing device 106 includes a print engine 404 that can comprise, for instance, a paper drive mechanism, photosensitive member, optical scanner, developing unit, fusing system, etc. Alternatively, the print engine 404 can comprise an inkjet-based print engine. The one or more user interface devices 406 typically comprise the interface tools with which the device settings can be changed and through which the user can communicate commands to the printing device 106. By way of example, the user interface devices 406 comprise one or more function keys and/or buttons with which the operation of the printing device 106 can be controlled, and a display, such as a liquid crystal display (LCD), with which information can be visually communicated to the user which commands may be entered by the user.

The memory 402 includes various programs (in software and/or firmware) including an O/S 414 that contains the various commands used to control the general operation of the printing device 106 and, optionally, a embedded network services 416. In addition, the memory 402 may include a printing device reimbursement manager 418 that facilitates reimbursement for work-related matters. Typically, the reimbursement manager 418 provides data corresponding to reimbursable items via the network 108. Operation of the printing device reimbursement manager 418 is similar to that described in conjunction with operation of the off-site reimbursement manager 318 in FIGS. 4 and 6.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computerreadable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computerreadable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 5 illustrates a high-level example of operation of the system 100 in processing reimbursement. With the system 100, a user may automatically reimburse a user account for resources consumed while working at an off-site location. Reimbursable items may not only include physical resources, such as paper, toner, and ink, but also include non-physical resources, such as access time (e.g., Internet access).

Beginning with block 500, the system 100 for processing reimbursement gathers data corresponding to reimbursable item, and sends the data via a network 108, such as the Internet, to a central location. The data may, for example, comprise the amount of toner or ink (monotone or color) consumed and the number of pieces of paper consumed. Alternatively, or in addition, the data can comprise information from which the consumption of such resources can be approximated. For instance, the amount and/or type of toner or ink consumed may be estimated by collecting information as to number of pages printed, the type and/or size of font used, whether an image was printed, whether color printing was used, etc.

In block 502, the system 100 reimburses the user using the sent data. This reimbursement may occur on a periodic basis (e.g., weekly, monthly, or quarterly). Generally speaking, the system 100 calculates the reimbursement depending on the nature and amount of consumed resources. For example, the amount the user is reimbursed per printed page may depend upon the type of paper used, the amount of toner or ink (monotone or color) used, the type of toner or ink, etc.

FIG. 6 illustrates an example of operation of an off-site reimbursement manager that facilitates reimbursement for work-related matters. This manager can comprise the off-site reimbursement manager 318 of the user computing device 102, or the optional manager 418 of the printing device 106. The off-site reimbursement manager is activated, as indicated in block 600, when the user prints a document. In the case of reimbursement manager 318, activation may occur in response to receipt of a “print” command entered with a user application executing on the user computing device 102 (e.g., Microsoft Word™). In the case reimbursement manager 418, activation may occur in response to receipt of a print job, for instance sent by an application executing on the user computing device 102. The off-site reimbursement manager 318 then prompts the user to enter authorization information, as indicated in block 602. Where the reimbursement manager comprises the manager 418 of the printing device 106, this prompting may comprise transmission of a request to the user computing device 102 that is to be presented to the user.

The off-site reimbursement manager 318, 418 receives the authorization information, as indicated in block 604. This information may be entered by the user with the user interface devices 306 of the user computing device 102, or possibly the user interface devices 406 of the printing device 106. The authorization information may include, for example, a social security number, the name of the user, the user's employee number, or any other information that may be used to identify the user and/or the user's authorization to receive reimbursement. Once this information is received, the off-site reimbursement manager 318, 418 sends the authorization information via the network 108, such as the Internet, to the central reimbursement manager 214, as indicated in block 606.

As indicted in block 608, it is then determined whether the user is authorized for reimbursement. This determination typically is made by the central reimbursement manager 214 of the central computing device 104, or an agent thereof. By way of example, the determination may comprise determining whether the user has registered with or enrolled in an appropriate reimbursement program, for instance, supported by the user's employer. If it is determined that the user lacks authorization, the off-site reimbursement manager 318, 418 may identify this condition to the off-site reimbursement manager 318, 418 that, in turn, notifies the user that he or she is unauthorized, as indicated in block 610. This notification may include a request that the user register or enroll with the reimbursement program. For instance, the user may be directed to a Web-site that permits the user to register with the program so that the user can later attempt to receive reimbursement. In that the user is determined to be unauthorized, flow for the session is terminated. The user can, optionally, be provided with several tries before being notified as to his or her lack of authorization to account for mere data entry (e.g., typing) mistakes made by the user in entering the authorization information. Notification may first require transmission of a notification message to the user computing device 102 where the reimbursement manager is the manager 418 of the printing device 106.

If it is determined that the user is authorized, the off-site reimbursement manager 318, 418 gathers data corresponding to reimbursable items and sends the data via the network 108 to the central reimbursement manager 214, as indicated in block 612. As a security measure, the off-site reimbursement manger 318, 418 may further gather validation information that confirms that the user is in fact using the consumed products for work-related matters. The validation information may include, for example, a portion of the printed document that is transmitted to a central location for later security review.

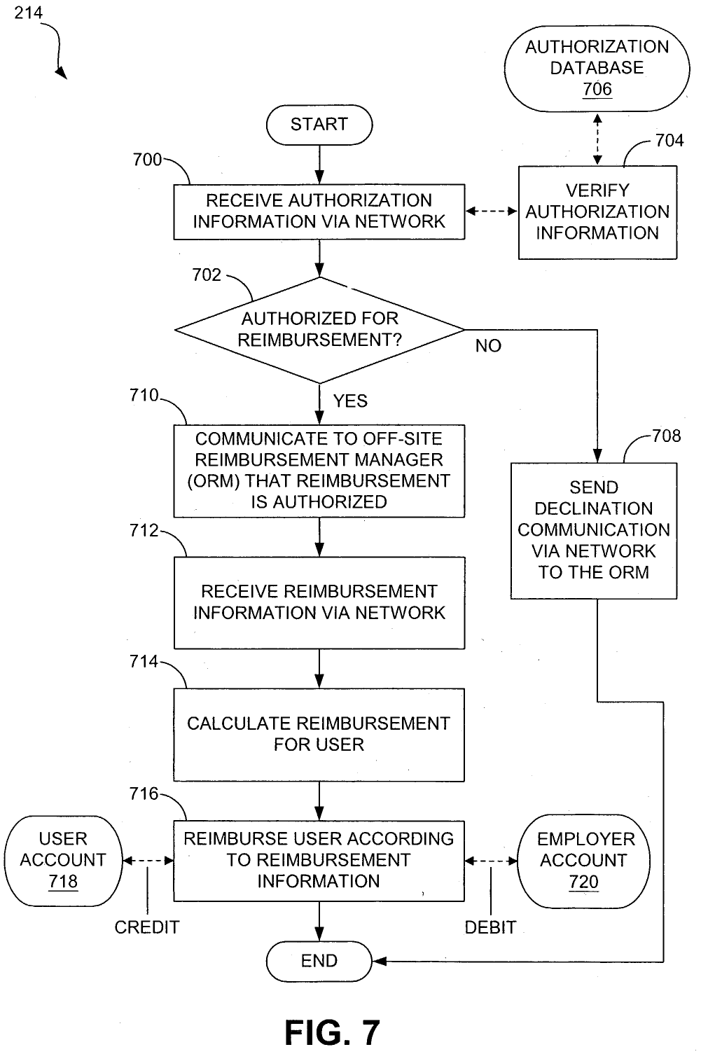

Once a reimbursement determination has been made by the central reimbursement manager 214 (see, e.g., FIG. 7), the off-site reimbursement manager 318, 418 may receive reimbursement information from the manager 214, as indicated in block 614, and then display the information to the user. Typically, the reimbursement information at least comprises the amount that will be credited to the user, and may further indicate, for instance, the rate reimbursed on a per-consumable basis, (such as rate per page and rate per unit weight of toner or ink).

FIG. 7 provides an example of operation of the central reimbursement manager 214 of the central computing device 104 enabling reimbursement of reimbursable items. Beginning with block 700 of FIG. 7, the central reimbursement manager 214 receives information corresponding to authorization for reimbursement via the network 108. As mentioned above with reference to FIG. 6, the information corresponding to authorization for reimbursement may include, for example, a social security number, the name of the user, the user's employee number or any other information that can be used to identify the user and/or confirm his or her authorization to receive reimbursement.

Once this information is received, the central reimbursement manager 214 determines whether the user is authorized for reimbursement as indicated in decision block 702. Verification (block 704) may be accomplished by comparing, for instance, the provided information with that contained in an authorization database 706 of the central reimbursement manager 214. Optionally, the verification may involve decryption where the provided information was encrypted.

With reference back to decision block 702, if the user is not authorized, the central reimbursement manager 214 sends a declination communication to the off-site reimbursement manager 318, 418 via the network 108 to notify the user that he or she is not authorized for receiving reimbursement, as indicated in block 708. Again, this notice may only be sent after several attempts by the user to establish his or her authorization.

If, on the other hand, the user is authorized for reimbursement, the central reimbursement manager 214 communicates to the off-site reimbursement manager 318, 418 that the user is authorized for reimbursement, as indicated in block 710, and, thereby, enables the off-site reimbursement manager 318, 418 to gather data corresponding to the reimbursable items.

Once the data corresponding to reimbursable items is gathered (see, e.g., FIG. 6), the central reimbursement manager 214 receives reimbursement information via the network 108, as indicated in block 712. As noted above, this information may be information that can be directly used to calculate the reimbursement (e.g., the amount of paper, toner, or ink used), or information that can be used to estimate resource consumption and then calculate reimbursement (e.g., type of font used, whether images were printed, colors of toner or ink used, etc.) as indicated in block 714. Therefore, the calculation may be determined by a fixed or variable rate per consumable resource, such as rate per printed page, rate per unit weight of toner or ink used, etc. Optionally, the calculation may also consider the geographic location in which the user lives and adjust reimbursement accordingly. Once the amount of reimbursement has been calculated, the central reimbursement manager 214 next reimburses the user (block 716) by crediting a user account 718 and debiting an employer account 720 in the amount calculated in block 714.

What is claimed is:

1. A system for processing reimbursement, comprising:
an off-site reimbursement manager configured to gather data corresponding to reimbursable items and send the data via a network; and
a central reimbursement manager configured to receive the data corresponding to reimbursable items via the network, wherein the central reimbursement manager is configured to reimburse in accordance with the received data.

2. The system as in claim 1, wherein the off-site reimbursement manager is further configured to request information corresponding to authorization for reimbursement and send the authorization information via the network to the central reimbursement manager.

3. The system as in claim 2, wherein the central reimbursement manager is further configured to verify the authorization information.

4. The system as in claim 1, wherein the central reimbursement manager is further configured to enable the off-site reimbursement manager to gather and send data corresponding to the reimbursable items.

5. The system as in claim 1, wherein the off-site reimbursement manager is configured to send validation information confirming that the reimbursable items were used in work-related matters.

6. The system as in claim 1, wherein the reimbursable items are one of paper, toner, or ink.

7. A method for facilitating reimbursement for work-related matters, comprising:
gathering data corresponding to reimbursable items in a first location; and
sending the data via a network to a second location, where the second location reimburses in accordance with the data.

8. The method as in claim 7, further comprising:
requesting information corresponding to authorization for reimbursement and sending the information to the second location via the network.

9. The method as in claim 7, further comprising:
sending validation information confirming that the reimbursable items were used in work-related matters.

10. A method for facilitating reimbursement for use of reimbursable items, comprising:
receiving data corresponding to the reimbursable items via a network from a first location; and
reimbursing in accordance with the received data.

11. The method as in claim 10, further comprising:
verifying information corresponding to authorization for reimbursement.

12. The method as in claim 10, further comprising:
enabling the first location to gather and send data corresponding to the reimbursable items.

13. The method as in claim 10, further comprising:
receiving validation information for proof of that the reimbursable items were used for work-related purposes.

14. An off-site reimbursement manager for providing data corresponding to reimbursable items, the manager stored in a computer-readable medium, the manager comprising:
logic configured to gather data corresponding to reimbursable items; and
logic configured to send the data via a network to enable reimbursement of reimbursable items.

15. The method as in claim 14, further comprising logic configured to request information corresponding to authorization for reimbursement and send the information via the network.

16. The method as in claim 14, further comprising logic configured to send validation information for proof of the reimbursable items via the network.

17. A central reimbursement manager for enabling reimbursement of reimbursable items, the manager stored on a computer-readable medium, the manager comprising:
logic configured to receive data corresponding to the reimbursable items via a network; and
logic configured to reimburse in accordance with the received data.

18. The central reimbursement manager as in claim 17, further comprising logic configured to verify information corresponding to authorization for reimbursement.

19. The central reimbursement manager as in claim 17, further comprising logic configured to enable gathering and sending data corresponding to the reimbursable items via the network to the central reimbursement manager.

20. The reimbursement manger as in claim 17, further comprising logic configured to receive validation information confirming that the reimbursable items were used in work-related matters.

21. A printing device, comprising:
a print engine;
a processing device; and
memory that includes an off-site reimbursement manager for enabling reimbursement of reimbursable items, a central reimbursement manager being configured to collect data corresponding to reimbursable items, and to send the data to a central reimbursement manager for the purpose of facilitating reimbursement.

22. The printing device as in claim 21, wherein the off-site reimbursement manager is further configured to receive and transmit information pertaining to a user's authorization to receive reimbursement.

23. The printing device as in claim 21, wherein the off-site reimbursement manager is further configured to collect data that validates that the reimbursable items were used for work-related purposes.

24. The printing device as in claim 23, wherein the off-site reimbursement manager is further configured to send a portion of print data to the central reimbursement manager as validation that the reimbursable items where used for work-related purposes.

25. A printing device, comprising:
a print engine;
a processing device;
means fore collecting data corresponding to the use of reimbursable items; and
means for sending the collected data to a central reimbursement manager for the purpose of facilitating reimbursement.
